(19) United States
(12) Patent Application Publication
(10) Pub. No.: US 2014/0033093 A1
(43) Pub. Date: Jan. 30, 2014

(54) MANIPULATING TABLES WITH TOUCH GESTURES

(71) Applicants: Andrew R. Brauninger, Seattle, WA (US); Ned B. Friend, Seattle, WA (US)

(72) Inventors: Andrew R. Brauninger, Seattle, WA (US); Ned B. Friend, Seattle, WA (US)

(73) Assignee: Microsoft Corporation, Redmond, WA (US)

(21) Appl. No.: 13/557,212

(22) Filed: Jul. 25, 2012

(51) Int. Cl. G06F 3/048

(52) U.S. Cl. 715/765

(57) ABSTRACT

A table processing system generates a user interface display of a table and receives a user input to display a table manipulation element. The table processing system receives a user touch input moving the table manipulation element and manipulates the table based on the user touch input. The manipulated table can then be used by the user.

### BACKGROUND

There are currently many different types of programs that enable a user to author documents. Document authoring tasks range from relatively simple tasks, such as typing a letter, to relatively complex tasks such as generating tables and manipulating tables within the document.

These types of complex document-authoring task are relatively straight forward when using a keyboard and a point and click device, such as a mouse. However, they can be quite difficult to perform using touch gestures on a touch sensitive screen. Such screens are often deployed on mobile devices, such as tablet computers, cellular telephones, personal digital assistants, multimedia players, and even some laptop and desktop computers.

One common table-authoring task is adding rows and columns to a table. Another common task is resizing table columns (or rows). Yet another common task when authoring tables is selecting table content. For instance, a user often wishes to select a column, a row, a cell, or a set of cells.

These types of tasks usually require a mouse (or other point and click device such as a track ball) because they are relatively high precision tasks. They are often somewhat difficult even with a mouse. For instance, resizing a column or row in a table requires moving the mouse directly over a line between two columns (or rows), then waiting for the cursor to change to indicate that the user can resize something, and then dragging the cursor to resize the column (or row). While this type of task can be somewhat difficult using a point and click device, it becomes very cumbersome when using touch gestures on a touch sensitive screen.

The discussion above is merely provided for general background information and is not intended to be used as an aid in determining the scope of the claimed subject matter.

### SUMMARY

A table processing system generates a user interface display of a table and receives a user input to display a table manipulation element. The table processing system receives a user touch input moving the table manipulation element and manipulates the table based on the user touch input. The manipulated table can then be used by the user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 is a block diagram of one illustrative table processing system.

FIG. 2 is a flow diagram illustrating one embodiment of the overall operation of the system shown in FIG. 1 in manipulating a table.

FIG. 3 is a flow diagram illustrating one embodiment of the operation of the system shown in FIG. 1 in selecting table content.

FIGS. 3A-3F are illustrative user interface displays.

FIG. 4 is a flow diagram illustrating one embodiment of the operation of the system shown in FIG. 1 in modifying the layout of a table.

FIGS. 4A-4J are illustrative user interface displays.

FIG. 5 shows one embodiment of a cloud computing architecture.

FIGS. 6-9 show various embodiments of mobile devices.

FIG. 10 shows a block diagram of one illustrative computing environment.

### DETAILED DESCRIPTION

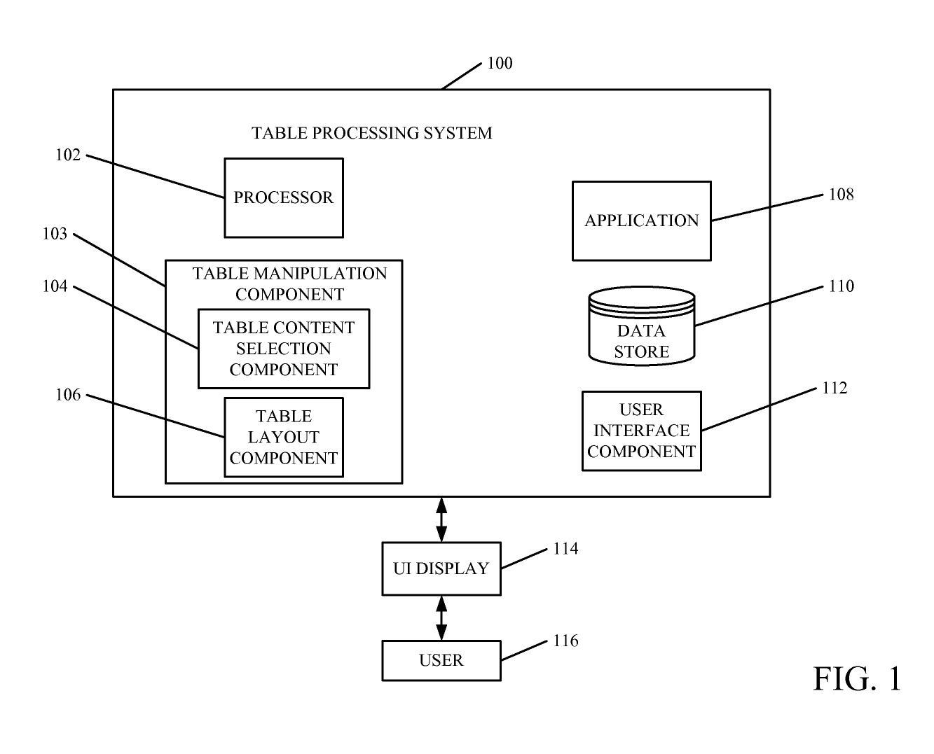

FIG. 1 is a block diagram of one embodiment of a table processing system 100. System 100 includes processor 102, table manipulation component 103 (which, itself, includes table content selection component 104, and table layout component 106) application 108, data store 110 and user interface component 112. FIG. 1 shows that system 100 generates user interface displays 114 for user 116. In one embodiment, processor 102 is a computer processor with associated memory and timing circuitry (not shown). It is a functional part of system 100 and is activated by, and facilitates functionality of other components and applications in system 100.

User interface component 112 generates the user interface displays 114 with user input mechanisms which receive user inputs from users 116 in order to access, and manipulate, table processing system 100. For instance, application 108 may be a document-authoring application (such as a word processing application, a spreadsheet, etc.) in which tables can be authored. User 116 uses user input mechanisms on user interface display 114 in order to interact with application 108. In one embodiment, user interface component 112 includes a touch sensitive display screen that displays user interface displays 114. User 116 uses touch gestures to provide user inputs to system 100 to interact with application 108.

Data store 110 illustratively stores data operated on by application 108, and used by the other components and processor 102, in system 100. Of course, data store 110 can be one data store or multiple different stores located locally or remotely from system 100.

Table manipulation component 103 illustratively operates to receive user inputs through user interface display 114 to manipulate tables generated by application 108. In one embodiment, table manipulation component 103 is part of application 108. However, in another embodiment, it is separate from application 108. It is shown separately for the sake of example only.

Table content selection component 104 illustratively receives user inputs through user interface display 114 and selects table content in a given table based on those user inputs. Table layout component 106 illustratively receives user inputs through user interface display 114 and changes the layout of the given table based on those inputs. This will be described in greater detail below.

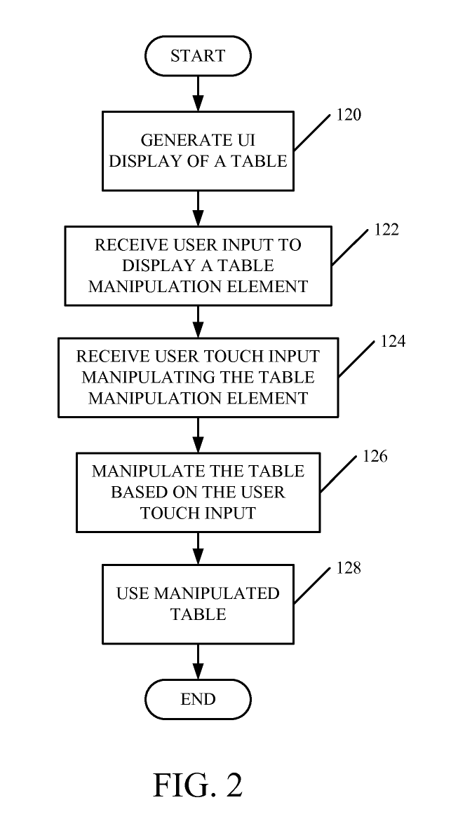

FIG. 2 is a flow diagram illustrating one embodiment of the overall operation of table processing system 100 in processing a table. In one embodiment, application 108, using user interface component 112, generates a user interface display of a table. Of course, this can be done by generating suitable user interfaces that the user can use to create a table, or by displaying an already-existing table. In any case, generating a user interface display of a table is indicated by block 120 in FIG. 2.

Table manipulation component 103 then receives a user input that causes table manipulation component 103 to display a table manipulation element on the user interface display 114 that is displaying the table. This is indicated by block 122 in FIG. 2. In one embodiment, the user touches the table on the user interface display screen, in order to place a caret or cursor somewhere within the table. This can cause table manipulation elements to be displayed. In another embodiment, as soon as the table is displayed on the user interface display, the table manipulation elements are displayed as well.

The table manipulation component 103 then receives a user touch input through user interface display 114 that manipulates the table manipulation element. This is indicated by block 124.

Table manipulation component 103 then manipulates the table based upon the user touch input. This is indicated by block 126.

By way of example, if the user moves the table manipulation component in a way that indicates that the user wishes to select content within the table, then table content selection component 104 causes that content to be selected. If manipulating the table manipulation element indicates that the user wishes to change the layout of the table, then table layout component 106 changes the layout as desired by the user.

Once the table has been manipulated based on the user touch inputs, the user can use the manipulated table, through application 108 or in any other desired way. This is indicated by block 128 in FIG. 2.

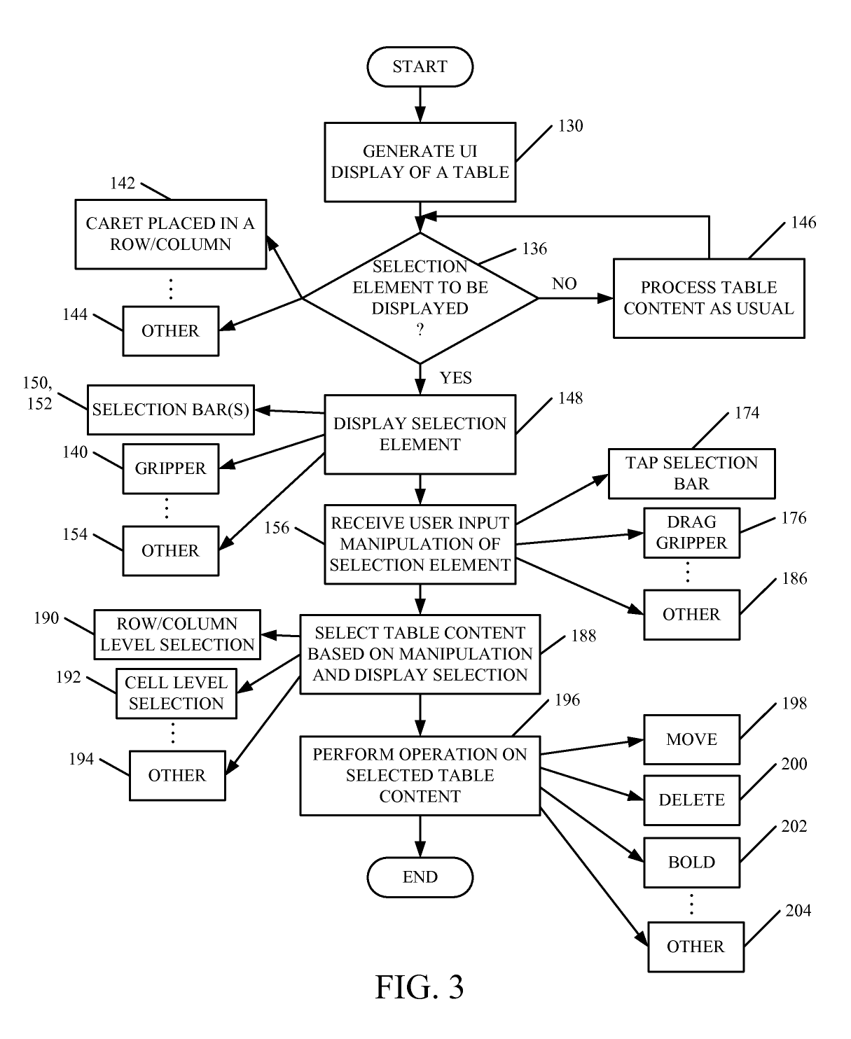

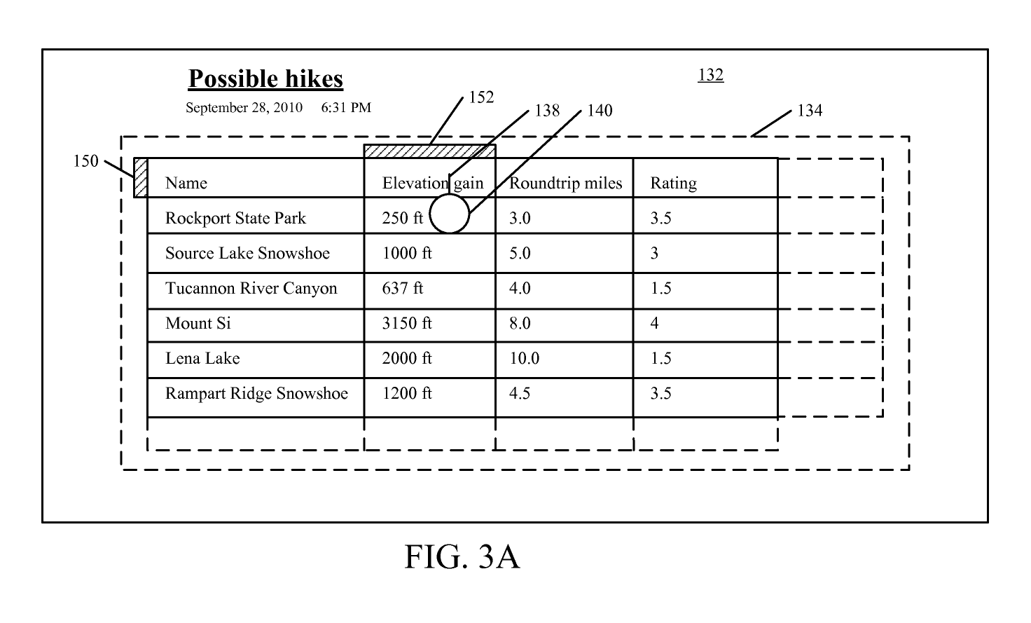

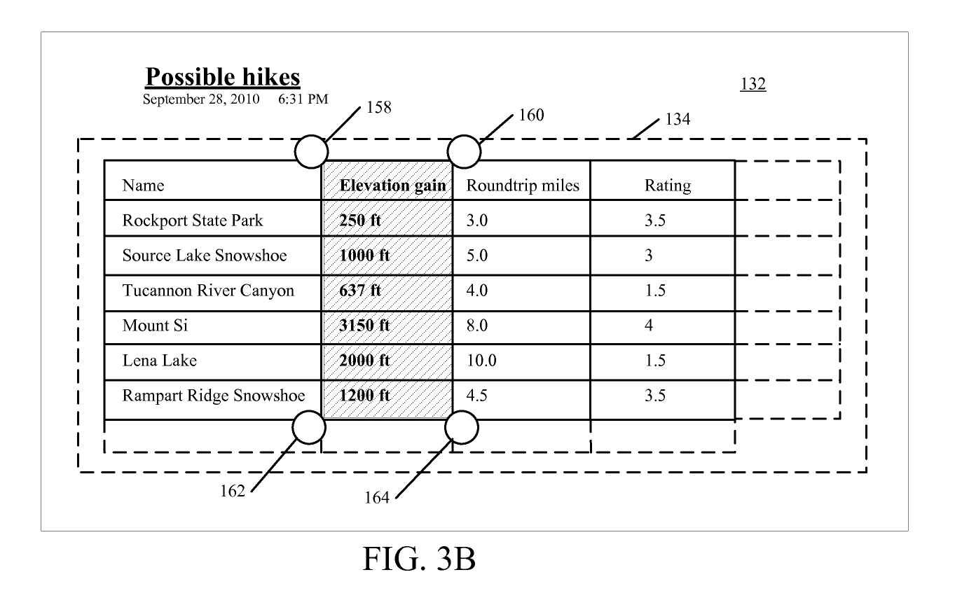

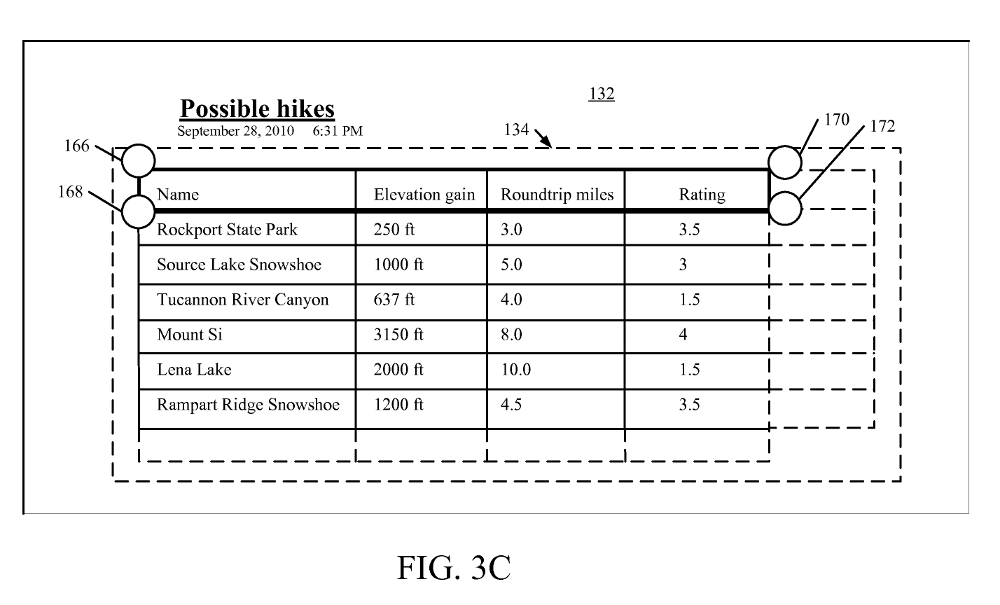

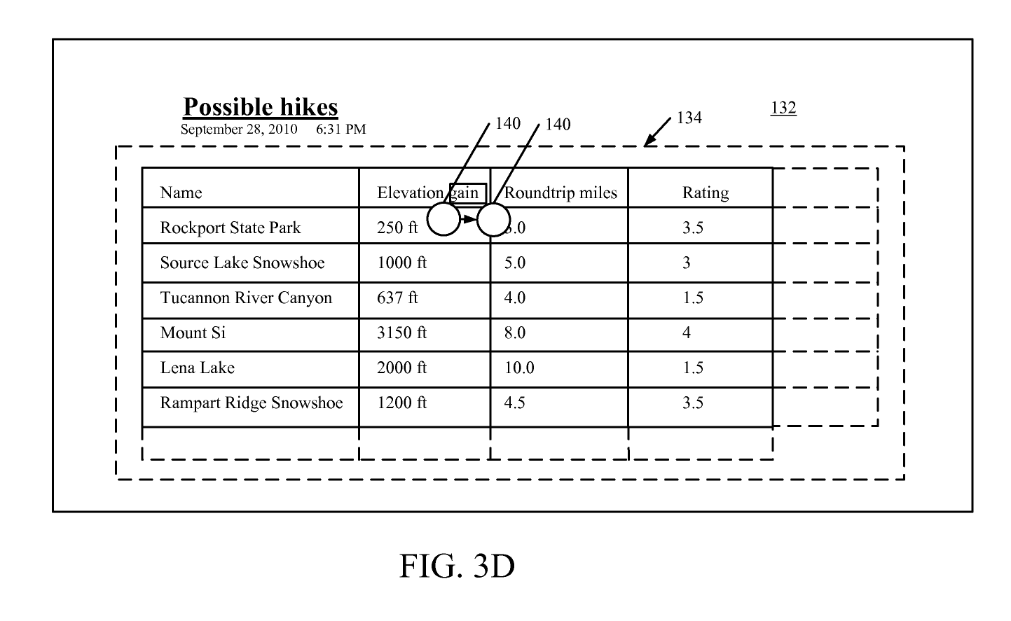

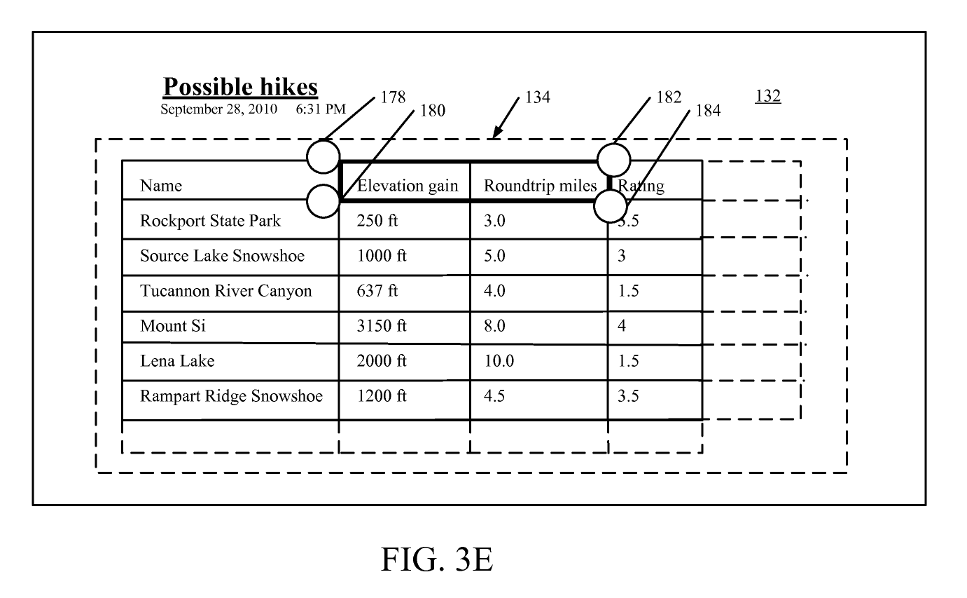

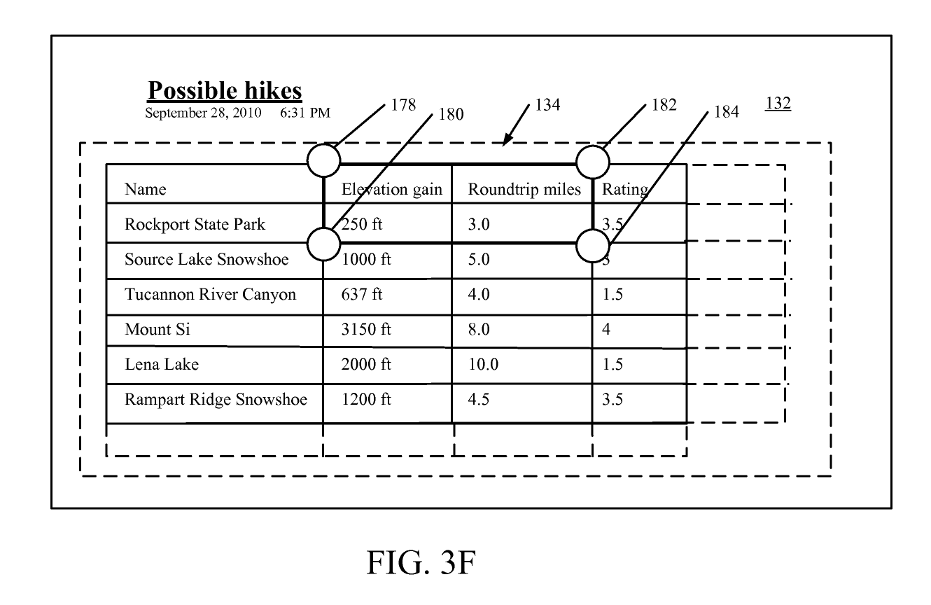

FIG. 3 is a flow diagram illustrating one embodiment of the operation of table content selection component 104 in selecting table content. FIGS. 3A-3F are user interface displays that illustrate this as well. FIGS. 3-3F will now be described in conjunction with one another.

In one embodiment, application 108 uses user interface component 112 to generate a user interface display of a table. This is indicated by block 130 in FIG. 3. FIG. 3A shows one exemplary user interface display 132 of a table 134. Table 134 has a plurality of columns entitled “Name”, “Elevation Gain”, “Roundtrip Miles” and “Rating”. Table 134 also has a plurality of rows.

Table content selection component 104 then determines whether a selection element is to be displayed (as the table manipulation element described with respect to FIG. 2 above) in table 134. This is indicated by block 136 in FIG. 3. It can be seen in FIG. 3A that the user has illustratively touched table 134 to place caret or cursor 138 a cell that is located in the “Elevation Gain” column and in the “Name” row. In one embodiment, placing the caret in a row or column of table 134 causes the selection element to be displayed. In the embodiment shown in FIG. 3A, the selection element corresponds to gripper 140 which is a displayed circle below caret 138. Placing the caret in the row or column is indicated by block 142. Of course, the user can perform any other desired actions to place the selection element (gripper 140) in table 134 as well, and this is indicated by block 144 in FIG. 3. In the event that the user has not taken an action which causes selection element 140 to be placed in table 134, application 108 simply processes the table 134 as usual. This is indicated by block 146 in FIG. 3.

However, assuming that the user has caused selection element 140 to be displayed, then table content selection component 104 displays element 140 on table 134. This is indicated by block 148 in FIG. 3. A variety of different selection elements can be displayed. In the embodiment shown in FIG. 3A, not only is gripper 140 shown as a selection element, but the selection elements can also be selection bars which include a row selection bar 150 and a column selection bar 152. Selection bars 150 and 152 are simply bars that are highlighted or otherwise visually distinguished from other portions of table 134 and located closely proximate a given row or column For instance, selection bar 150 is a row selection bar that is closely proximate the “Name” row while column selection bar 152 is closely proximate the “Elevation Gain” column. Of course, other user input mechanisms can be used as selection elements as well, and this is indicated by block 154 in FIG. 3.

In any case, once the selection element is displayed, table content selection component 104 illustratively receives a user input manipulation of the selection element that indicates what particular content of table 134 the user wishes to select. This is indicated by block 156 in FIG. 3. This can take a variety of different embodiments. For instance, if the user taps one of the selection bars 150 or 152, this causes table content selection component 104 to select the entire row or column corresponding to the selection bar 150 or 152, respectively. By way of example, assume that the user has tapped on, or touched (or used another touch gesture to select) column selection bar 152. This causes the entire column corresponding to selection bar 152 to be selected.

FIG. 3B shows an embodiment of user interface display 132, with table 134, after the user has tapped on selection bar 152. It can be seen that the entire “Elevation Gain” column corresponding to selection bar 152 has now been bolded (or highlighted or otherwise visually distinguished from the remainder of table 134) to show that it has been selected. In addition, table content selection component 104 displays a plurality of grippers 158, 160, 162 and 164 to identify the corners (or boundaries) of the column that has been selected.

FIG. 3C shows another embodiment of user interface display 132 after the user has tapped selection bar 150. It can be seen in FIG. 3C that the entire “Name” row corresponding to row selection bar 150 has been selected, and table content selection component 104 also displays grippers 166, 168, 170 and 172 that define the corners, or boundaries, of the selected row. Tapping one of the selection bars to select content in table 134 is indicated by block 174 in FIG. 3.

In another embodiment, instead of tapping a selection bar, the user touches, and drags, gripper 140 in FIG. 3A. Dragging the gripper is indicated by block 176 in FIG. 3. The particular way that the user manipulates gripper 140 determines what content of table 134 is selected.

For instance, if the user drags the gripper within a single cell of table 134, then only content within that cell is selected. However, in another embodiment, if the user drags the gripper across a cell boundary, then further movement of the gripper causes content to be selected on a cell-by-cell basis. That is, as the user crosses cell boundaries with gripper 140, additional cells are selected in table 134. If the user wishes to simply select a set of contiguous cells in table 134, the user simply drags gripper 140 across those cells.

FIG. 3D shows an embodiment of a user interface display in which gripper 140 has been touched and dragged to the right within the “Elevation Gain” cell in table 134. As shown, the gripper 140 has not crossed a cell boundary so only the text (in this case the word “gain”) within the cell is selected. FIG. 3E shows an embodiment in which the user has dragged gripper 140 across the cell boundary between the “Elevation Gain” cell and the “Roundtrip Miles” cell. This causes table content selection component 104 to select both of those cells within table 134. Once they have been selected, component 104 causes four grippers to be displayed around the multi-cell selection. Those grippers are indicated as 178, 180, 182 and 184.

FIG. 3F shows another embodiment in which gripper 140 has been dragged so it not only crosses the boundary between the two cells selected in FIG. 3, but it has also been dragged downwardly on table 134 so that it selects the “250 ft” and “3.0” cells in table 134. It can be seen that grippers 178-184 now define the corners, or boundary, of the four selected cells in FIG. 3F.

Of course, the user can select content within table 134 in other ways as well. This is indicated by block 186 in FIG. 3.

Once the user has manipulated the selection element as desired (as shown in the user interface displays of FIGS. 3A-3F) table content selection component 104 selects the table content based upon the manipulation and displays that selection. For instance, component 104 can display the selected cells or rows or columns as being highlighted, in bold, or in another way that visually distinguishes them, and identifies them as being selected, within the displayed table. Selecting the table content is indicated by block 188, and selecting rows or columns, making a cell level selection, or selecting in other ways, is indicated by blocks 190, 192, and 194, respectively.

Once the table content has been selected, user 116 can interact with application 108 to perform any desired operation on the selected table content. This is indicated by block 196 in FIG. 3. For instance, the user can move the table content within table 134. This is indicated by block 198. The user can delete the table content, as indicated by block 200. The user can bold the content, as indicated by block 202, or the user can perform any of a wide variety of other operations on the selected table content. This is indicated by block 204 in FIG. 3.

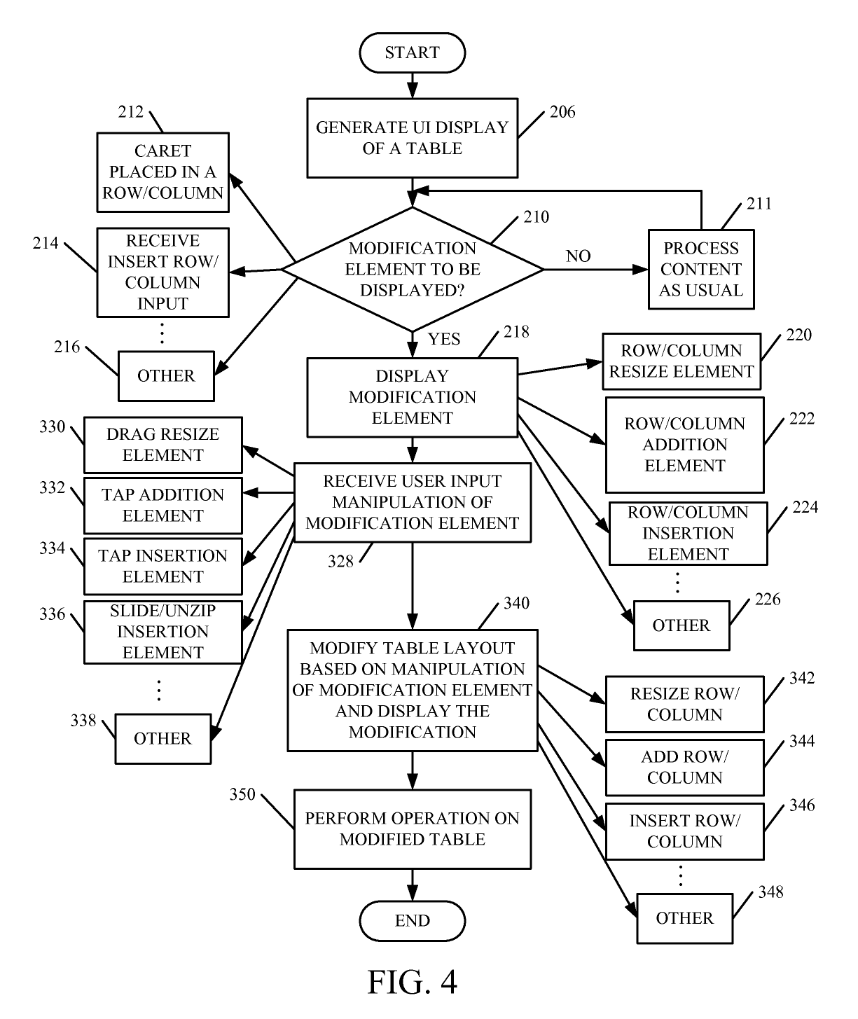

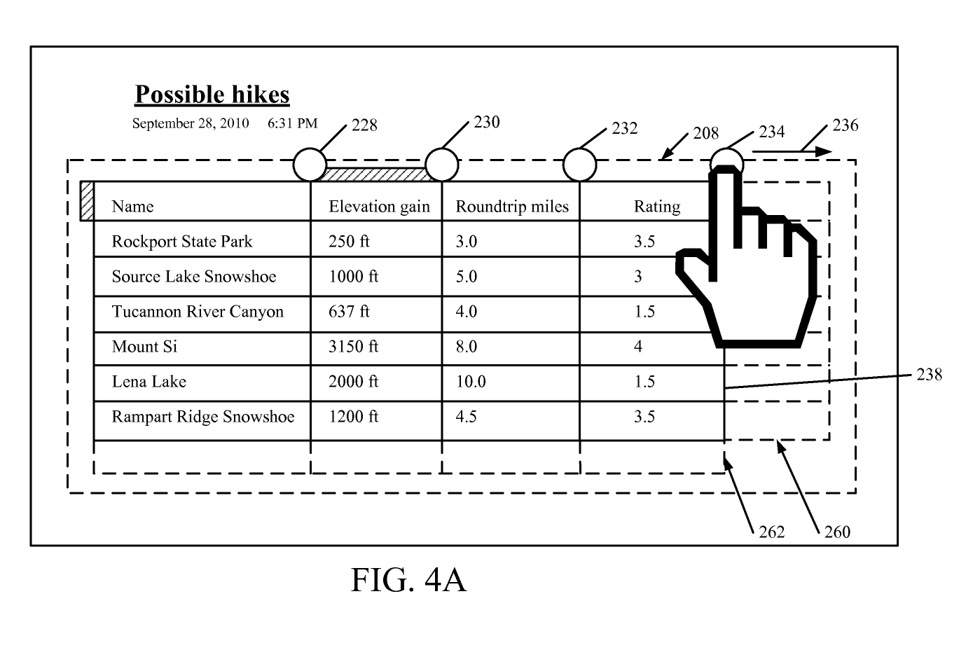

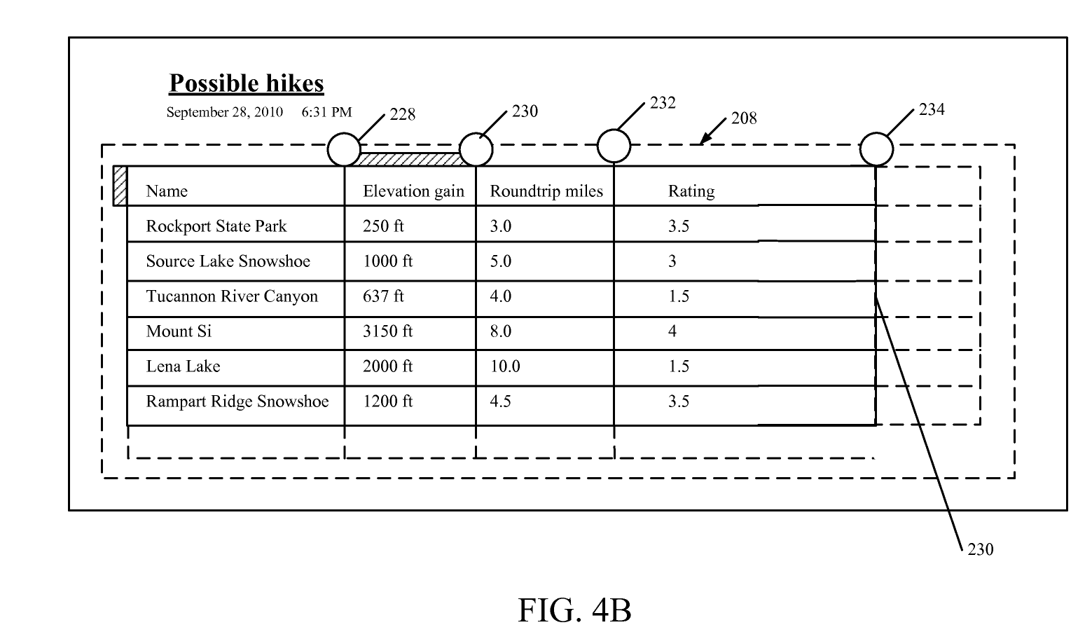

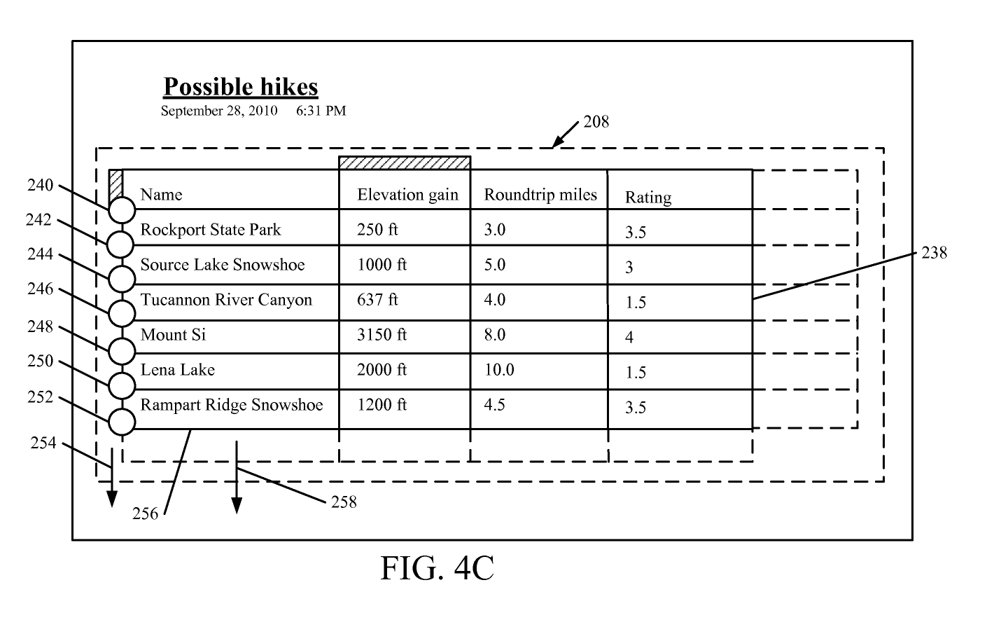

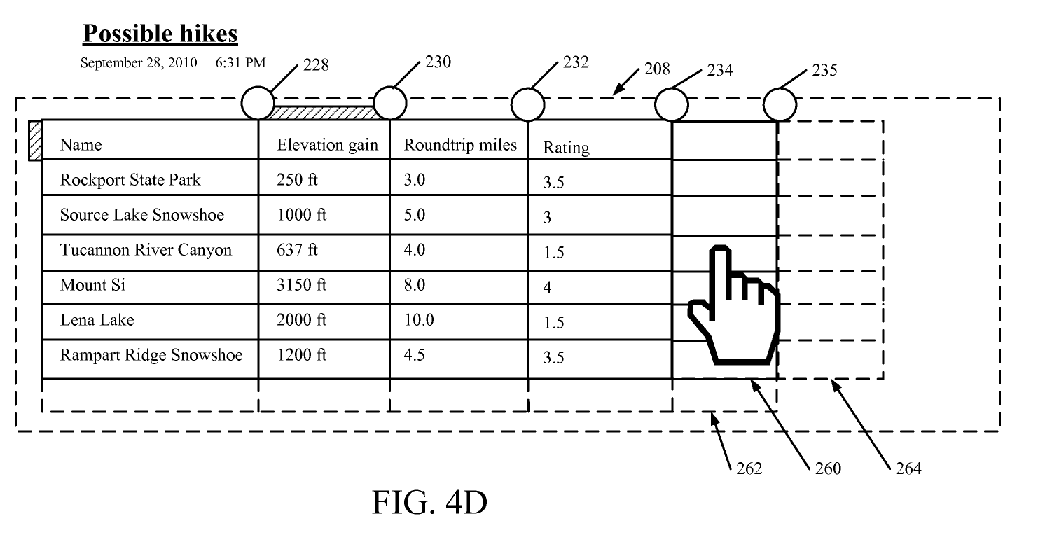

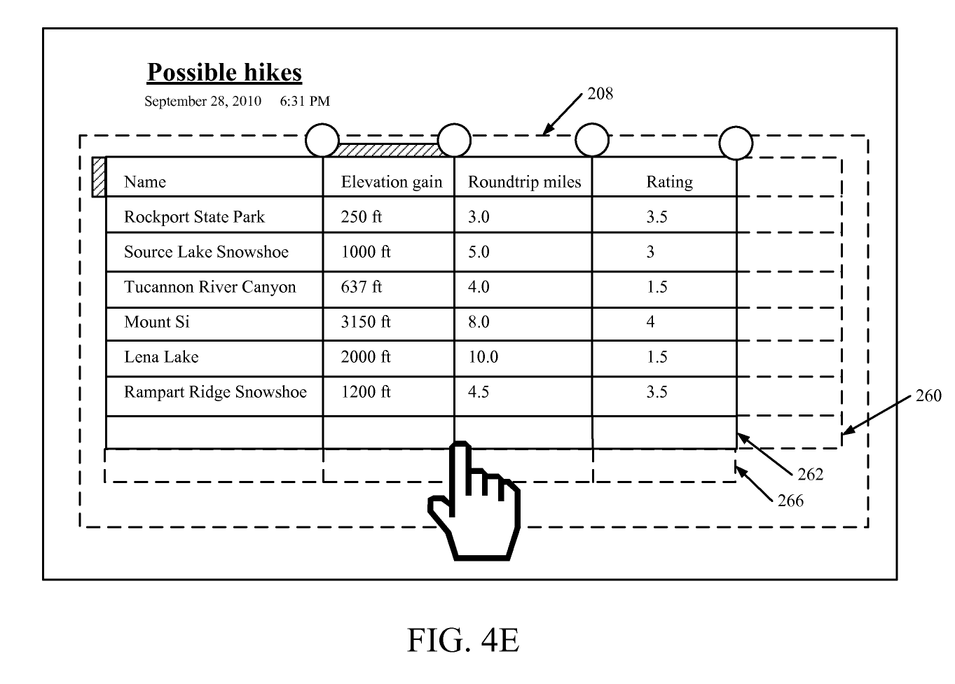

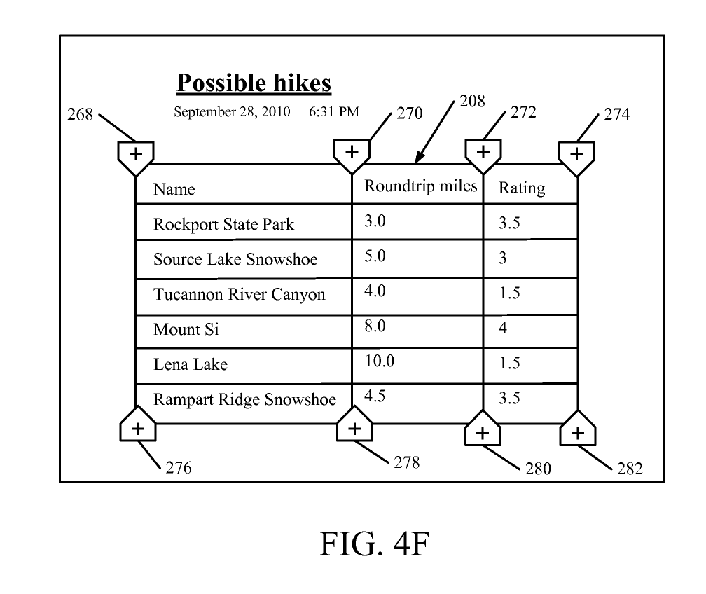

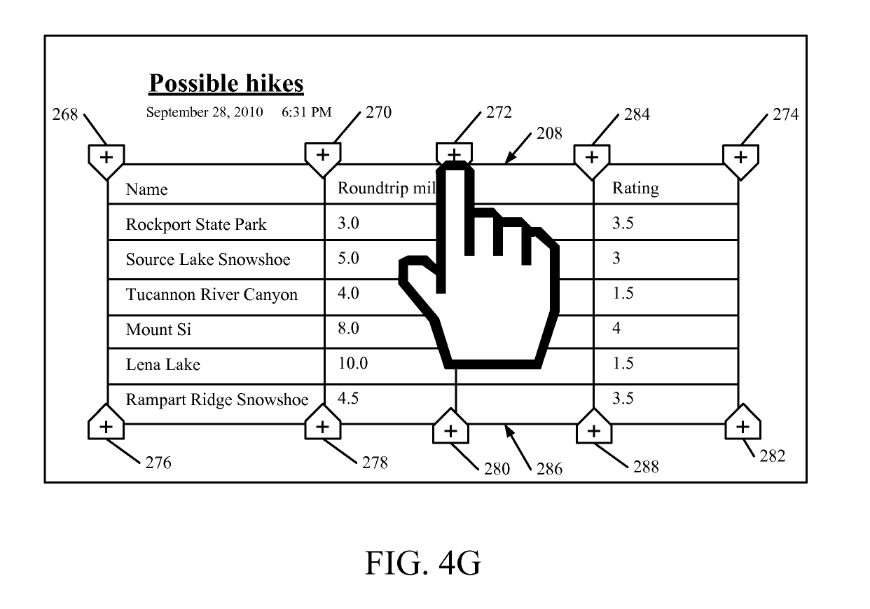

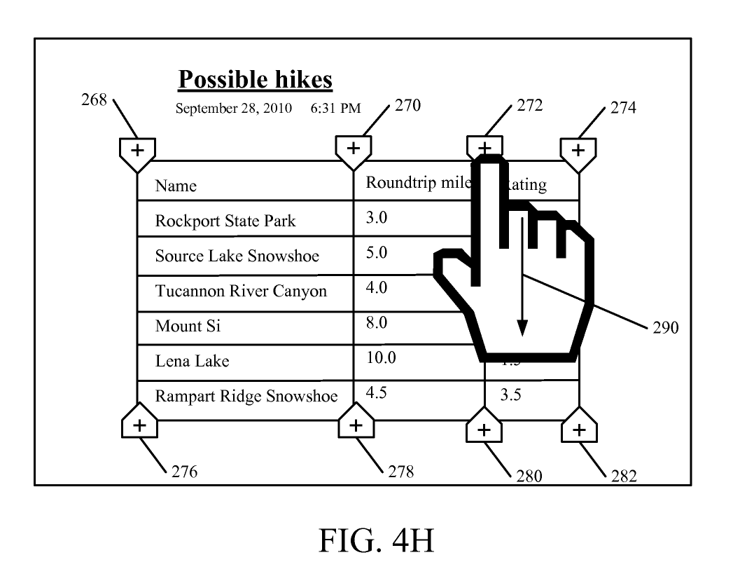

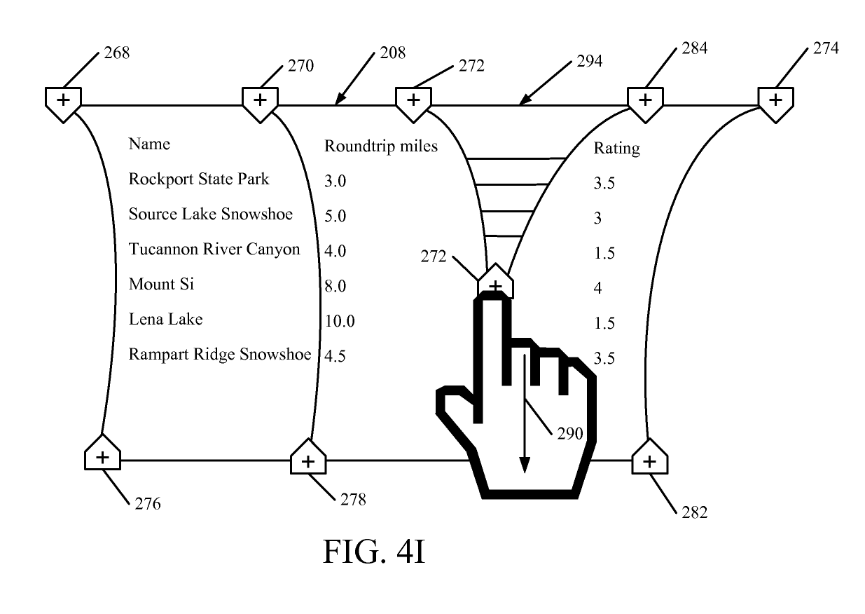

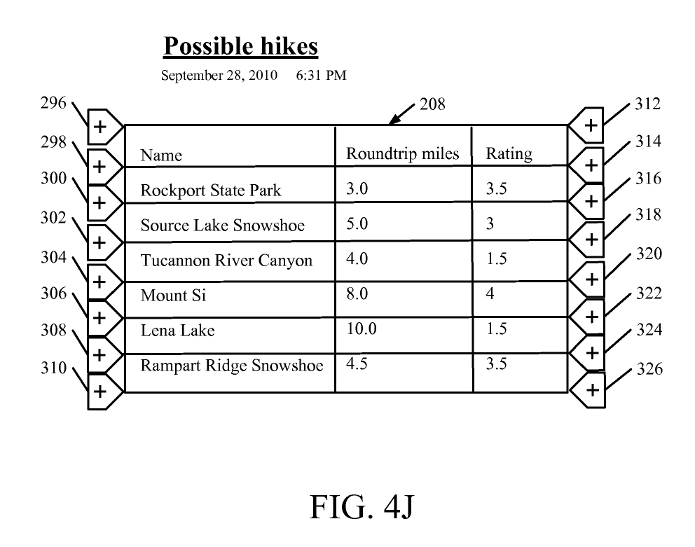

FIG. 4 is a flow diagram illustrating one embodiment of the operation of table layout component 106 in modifying the table layout of table 134. First, system 100 generates a user interface display of a table. This is indicated by block 206 in FIG. 4. FIG. 4A shows one embodiment of a table 208. Table 208 is similar to table 134, and it has similar content.

Table manipulation component 103 then determines whether a modification element is to be displayed on table 208. This is indicated by block 210 in FIG. 4. If, at block 210, it is determined that the modification element is not to be displayed in table 208, then system 100 simply processes the content of table 208 as usual. This is indicated by block 211 in FIG. 4.

As with the content selection element described with respect to FIGS. 3-3F above, the modification element can be placed in table 208 in one of a wide variety of different ways. For instance, if the user touches table 208 to place a caret or cursor in a row or column in table 208, this can cause the modification element to be displayed. This is indicated by block 212 in FIG. 4. Additionally, user 116 may navigate (through a menu or otherwise) to a command input that allows the user to command system 100 to enter a mode where a row or column can be inserted in table 208. Receiving an insert row/column input from the user is indicated by block 214 in FIG. 4. Of course, a wide variety of other user inputs can be used to cause table manipulation component 103 to display a modification element in table 208. These other ways are indicated by block 216 in FIG. 4.

If, at block 210, it is determined that the modification element is to be displayed, then table layout component 106 displays the modification element in table 208. This is indicated by block 218 in FIG. 4. There are various embodiments that can be used to display a modification element. In one embodiment, table layout component 106 can display a modification element that allows the user to easily resize a row or column Displaying a row/column resize element is indicated by block 220 in FIG. 4.

In another embodiment, component 106 can display an element that allows the user to easily add a row or column. Displaying a row/column addition element is indicated by block 222 in FIG. 4.

In another embodiment, component 106 can display an element that easily allows the user to insert a row or column within table 208. Displaying a row/column insertion element is indicated by block 224. There are a wide variety of other elements that can be displayed as well. This is indicated by block 226 in FIG. 4.

FIG. 4A is displayed with a modification element that allows the user to resize a column Column resize elements 228, 230, 232 and 234, in the embodiment show in FIG. 4A, simply appear as circles located at the top of, and visually attached to, the boundary lines that delineate columns in table 208. As the user touches one of the column resize elements 228-234, and slides it to the right or left, this causes the corresponding boundary to be moved to the right or to the left, respectively. For instance, if the user touches column resize element 234 and slides it to the right, as indicated by arrow 236, this causes the boundary line 238 on the right side of the “Rating” column to be moved along with element 234 in the direction indicated by arrow 236. That is, this makes the “Rating” column wider. FIG. 4B shows an embodiment in which the user has placed his or her finger on element 234 and moved it to the right. It can be seen that line 238 has also been moved to the right, making the “Rating” column wider.

FIG. 4C shows another user interface display displaying table 208. FIG. 4C is similar to that shown in FIG. 4A, except that the resize elements are now row resize elements 240, 242, 244, 246, 248, 250 and 252, instead of column resize elements. The row resize elements also appear as circles attached to the lines that delineate the rows in table 208. If the user touches one of row resize elements 240-252 and slides it up or down, the corresponding row boundary will move with it resizing the rows making them taller or shorter. For instance, if the user places his or her finger on row resize element 252 and moves it downward generally in the direction indicated by arrow 254, then the line 256 that defines the lower boundary of the “Rampart Ridge Snowshoe” row will move downwardly as well, in the direction indicated by arrow 258. This will make the last row in table 208 taller.

It should be noted that the embodiment in which the row/column resize elements are circles attached to corresponding lines is exemplary only. They could be any other shape and they could be displayed in other locations (such as at the bottom or at the right side of, table 208). Of course, other shapes and sizes of elements, and other arrangements are contemplated herein as well.

FIG. 4A also shows an embodiment in which table layout component 106 displays a row/column addition element. In the example shown in FIG. 4A, an additional column (in addition to those actually in table 208) is displayed in phantom (or in ghosting) to the right of the “Rating” column The phantom column 260 is shown in dashed lines. Similarly, a row below the last actual row in table 208 (below the “Rampart Ridge Snowshoe” row) is also shown in phantom (or ghosted). The phantom row 262 is shown in dashed lines in FIG. 4A. In one embodiment, if the user simply taps the ghost column 260, table layout component 106 automatically adds an additional column in place of the ghost column 260, and adds another ghost column to the right of the added column FIG. 4D shows a user interface display that better illustrates this. FIG. 4D shows that the user has tapped ghost column 260, and table layout component 106 has thus added column 260 as an actual column to table 208. In addition, table layout component 106 has added an additional ghosted column 264 to the right of the new actual column 260. It can be seen in FIG. 4D that component 106 has also added a new column resize element 235 for the newly added column 260. Therefore, if the user wishes to add multiple columns to table 208, the user simply first taps ghost column 260, then taps ghost column 264, and continues tapping the newly added ghost columns until the table 208 has the desired number of columns

FIG. 4E shows an embodiment in which the user has tapped ghost row 262. It can be seen that table layout component 106 generates table 208 with an additional actual row 262 that replaces ghost row 262. In addition, component 106 has also generated a new ghost row 266. Therefore, if the user wishes to add multiple rows to table 208, the user simply taps ghost row 262 and then taps ghost row 266, and continues tapping the additional ghost rows that are added each time a new actual row is added to table 208, until the table 208 has the desired number of rows. Of course, if there were row resize elements displayed on table 208 in FIG. 4E, in one embodiment, table layout component 106 would add one for the newly added row 262 so that it could easily be resized by the user as well.

FIG. 4F shows an embodiment where table layout component 106 has generated a display of column insertion elements in table 208. In the embodiment shown in FIG. 4F, table insertion elements are indicated by numerals 268, 270, 272, 274, 276, 278, 280 and 282. The actual displayed elements can take any of a wide variety of forms and those shown are for exemplary purposes only. In addition, while they are shown displayed at the boundaries between the columns in table 208, they could be displayed at other locations as well.

In any case, in one embodiment, the user interacts with one of the column insertion elements 268-282 and table layout component 106 receives an input indicative of that interaction and inserts a column in an appropriate location. By way of example, if the user taps on column insertion element 272, this causes table layout component 106 to insert a column between the “Roundtrip miles” column and the “Rating” column Of course, in one embodiment, this will happen if the user taps on column insertion element 280 as well. If the user taps on one of elements 274 or 282, this causes component 106 to add a column to the right of those elements. Similarly, if the user taps on one of elements 268 and 276, this causes component 106 to add a column to the left of those elements in table 208.

In the embodiment shown in FIG. 4F, the user has first entered a column insert mode of operation as discussed above, and this causes the table insertion elements 268-282 to appear. Of course, this is optional, and the elements displayed in FIG. 4F can be displayed in response to other user inputs as well.

FIG. 4G shows a user interface display of table 208 where the user has tapped on column insert element 272. This causes component 106 to insert a new column 286 between the “Roundtrip miles” column and the “Rating” column Component 106 illustratively repositions the “Rating” column to the right of its original location to make room for new column 286. In addition, it can be seen that component 106 has also generated a display of two additional column insert elements 284 and 288 that reside between the new column 286 and the “Rating” column.

It will also be appreciated that the user can interact with one of the column insertion elements in other ways as well, in order to insert a column FIG. 4H shows that, in one such embodiment, the user has touched column insert element 272 and begins dragging it downwardly generally in the direction indicated by arrow 290. In one embodiment, this causes table layout component 106 to generate a display that shows element 272 acting as a zipper to unzip table 208 between the “Roundtrip miles” column and the “Rating” column to add an additional column For instance, FIG. 4I shows one such embodiment. It can be seen that the user is dragging column insert element 272 downwardly in the direction indicated by arrow 290. In response, table layout component 106 is generating a display that “unzips” table 208 to insert a new table 294, between the “Roundtrip miles” and the “Rating” columns Of course, when the user has “unzipped” element 272 all the way to the bottom of table 208, the net effect is similar to that shown in FIG. 4G, in which a new column has been added between the “Roundtrip miles” column and the “Rating” column.

FIG. 4J shows another embodiment in which table layout component 106 has generated row insert elements 296, 298, 300, 302, 304, 306, 308 and 310. In addition, component 106 has generated row insert elements 312, 314, 316, 318, 320, 322, 324, and 326. Operation of elements 296-326 is similar to the column insert elements described above with respect to FIGS. 4F-4I. Therefore, the user can tap one of elements 296-326 to add a row to table 208, or the user can slide one of elements 296-326 to unzip table 208 to add a row, or the user can perform other manipulations on elements 296-326 to add a row to table 208.

Receiving any of the user input manipulations of the modification elements discussed above is indicated by block 328 in FIG. 4. Specifically, dragging the resize elements is indicated by block 330, tapping an addition element is indicated by block 332, tapping an insertion element is indicated by block 334, sliding or unzipping an insertion element is indicated by block 336, and manipulating the modification element in another way is indicated by block 338.

In response to any of these inputs, table layout component 106 modifies the layout of the table based on the manipulation of the modification element, and displays that modification. This was described above with respect to FIGS. 4A-4J, and it is indicated by block 340 in FIG. 4. Resizing a row or column is indicated by block 342, adding a row or column is indicated by block 344, inserting a row or column is indicated by block 346, and other modifications are indicated by block 348.

Once the table has been modified as desired by the user, the user can perform operations on the modified table, and this is indicated by block 350 in FIG. 4

It will be appreciated that the size, shape and locations of the displayed elements discussed herein is exemplary only. They could be different size or shape or they could be located in other places on the user interface displays as well.

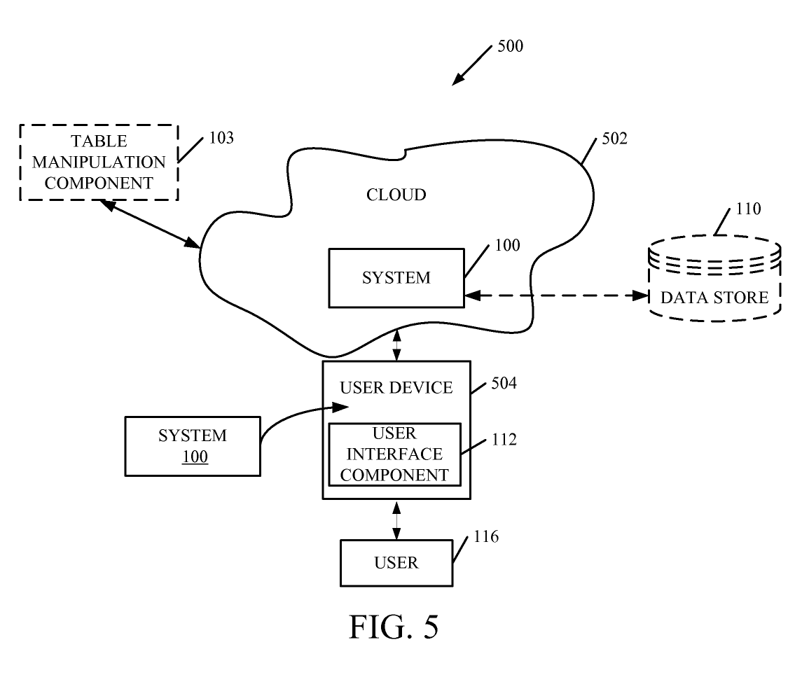

FIG. 5 is a block diagram of system 100, shown in FIG. 1, except that it is disposed in a cloud computing architecture 500. Cloud computing provides computation, software, data access, and storage services that do not require end-user knowledge of the physical location or configuration of the system that delivers the services. In various embodiments, cloud computing delivers the services over a wide area network, such as the internet, using appropriate protocols. For instance, cloud computing providers deliver applications over a wide area network and they can be accessed through a web browser or any other computing component. Software or components of system 100 as well as the corresponding data, can be stored on servers at a remote location. The computing resources in a cloud computing environment can be consolidated at a remote data center location or they can be dispersed. Cloud computing infrastructures can deliver services through shared data centers, even though they appear as a single point of access for the user. Thus, the components and functions described herein can be provided from a service provider at a remote location using a cloud computing architecture. Alternatively, they can be provided from a conventional server, or they can be installed on client devices directly, or in other ways.

The description is intended to include both public cloud computing and private cloud computing. Cloud computing (both public and private) provides substantially seamless pooling of resources, as well as a reduced need to manage and configure underlying hardware infrastructure.

A public cloud is managed by a vendor and typically supports multiple consumers using the same infrastructure. Also, a public cloud, as opposed to a private cloud, can free up the end users from managing the hardware. A private cloud may be managed by the organization itself and the infrastructure is typically not shared with other organizations. The organization still maintains the hardware to some extent, such as installations and repairs, etc.

In the embodiment shown in FIG. 5, some items are similar to those shown in FIG. 1 and they are similarly numbered. FIG. 5 specifically shows that system 100 is located in cloud 502 (which can be public, private, or a combination where portions are public while others are private). Therefore, user 116 uses a user device 504 to access those systems through cloud 502.

FIG. 5 also depicts another embodiment of a cloud architecture. FIG. 5 shows that it is also contemplated that some elements of system 100 are disposed in cloud 502 while others are not. By way of example, data store 110 can be disposed outside of cloud 502, and accessed through cloud 502. In another embodiment, table manipulation component 103 is also outside of cloud 502. Regardless of where they are located, they can be accessed directly by device 504, through a network (either a wide area network or a local area network), they can be hosted at a remote site by a service, or they can be provided as a service through a cloud or accessed by a connection service that resides in the cloud. Also, system 100, or components of it, can be located on device 504 as well. All of these architectures are contemplated herein.

It will also be noted that system 100, or portions of it, can be disposed on a wide variety of different devices. Some of those devices include servers, desktop computers, laptop computers, tablet computers, or other mobile devices, such as palm top computers, cell phones, smart phones, multimedia players, personal digital assistants, etc.

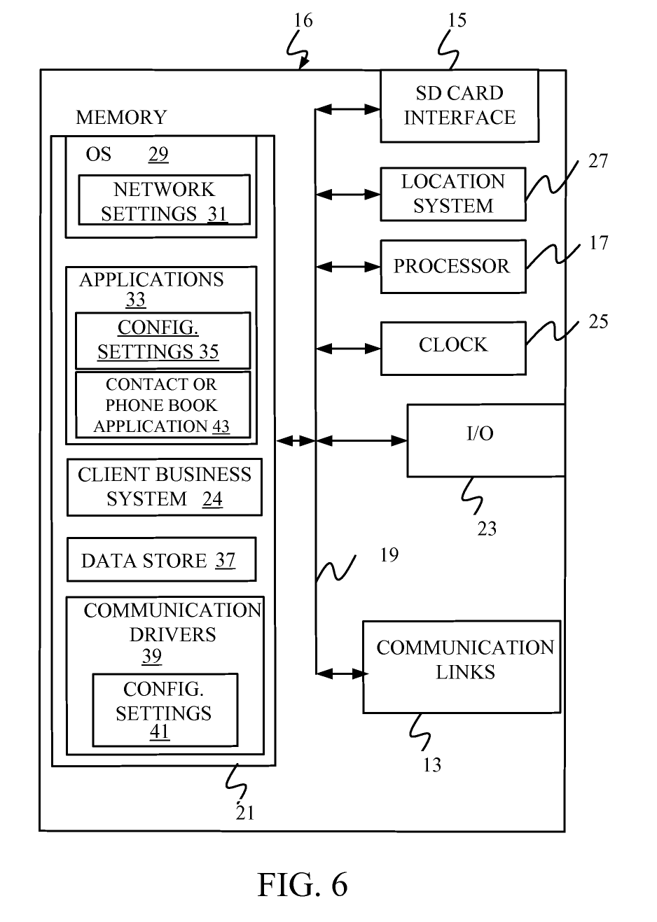

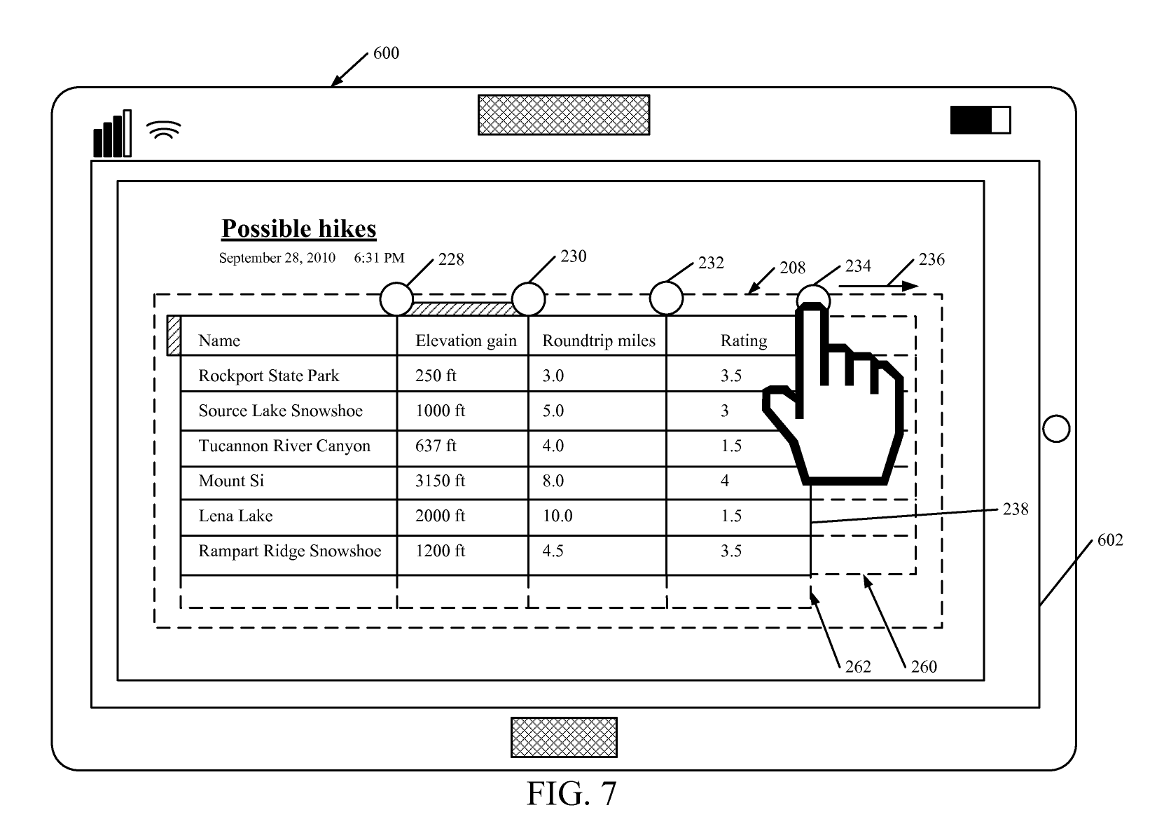

FIG. 6 is a simplified block diagram of one illustrative embodiment of a handheld or mobile computing device that can be used as a user's or client's hand held device 16, in which the present system (or parts of it) can be deployed. FIGS. 7-9 are examples of handheld or mobile devices.

FIG. 6 provides a general block diagram of the components of a client device 16 that can run components of system 100 or that interacts with system 100, or both. In the device 16, a communications link 13 is provided that allows the handheld device to communicate with other computing devices and under some embodiments provides a channel for receiving information automatically, such as by scanning. Examples of communications link 13 include an infrared port, a serial/USB port, a cable network port such as an Ethernet port, and a wireless network port allowing communication though one or more communication protocols including General Packet Radio Service (GPRS), LTE, HSPA, HSPA+ and other 3G and 4G radio protocols, 1×rtt, and Short Message Service, which are wireless services used to provide cellular access to a network, as well as 802.11 and 802.11b (Wi-Fi) protocols, and Bluetooth protocol, which provide local wireless connections to networks.

Under other embodiments, applications or systems (like system 100) are received on a removable Secure Digital (SD) card that is connected to a SD card interface 15. SD card interface 15 and communication links 13 communicate with a processor 17 (which can also embody processors 102 from FIG. 1) along a bus 19 that is also connected to memory 21 and input/output (I/O) components 23, as well as clock 25 and location system 27.

I/O components 23, in one embodiment, are provided to facilitate input and output operations. I/O components 23 for various embodiments of the device 16 can include input components such as buttons, touch sensors, multi-touch sensors, optical or video sensors, voice sensors, touch screens, proximity sensors, microphones, tilt sensors, and gravity switches and output components such as a display device, a speaker, and or a printer port. Other I/O components 23 can be used as well.

Clock 25 illustratively comprises a real time clock component that outputs a time and date. It can also, illustratively, provide timing functions for processor 17.

Location system 27 illustratively includes a component that outputs a current geographical location of device 16. This can include, for instance, a global positioning system (GPS) receiver, a LORAN system, a dead reckoning system, a cellular triangulation system, or other positioning system. It can also include, for example, mapping software or navigation software that generates desired maps, navigation routes and other geographic functions.

Memory 21 stores operating system 29, network settings 31, applications 33, application configuration settings 35, data store 37, communication drivers 39, and communication configuration settings 41. Memory 21 can include all types of tangible volatile and non-volatile computer-readable memory devices. It can also include computer storage media (described below). Memory 21 stores computer readable instructions that, when executed by processor 17, cause the processor to perform computer-implemented steps or functions according to the instructions. System 100 or the items in data store 110, for example, can reside in memory 21. Similarly, device 16 can have a client business system 24 which can run various business applications or embody parts or all of system 100. Processor 17 can be activated by other components to facilitate their functionality as well.

Examples of the network settings 31 include things such as proxy information, Internet connection information, and mappings. Application configuration settings 35 include settings that tailor the application for a specific enterprise or user. Communication configuration settings 41 provide parameters for communicating with other computers and include items such as GPRS parameters, SMS parameters, connection user names and passwords.

Applications 33 can be applications that have previously been stored on the device 16 or applications that are installed during use, although these can be part of operating system 29, or hosted external to device 16, as well.

FIG. 7 shows one embodiment in which device 16 is a tablet computer 600. In FIG. 7, computer 600 is shown with the user interface display of FIG. 4B. Screen 602 can be a touch screen (so touch gestures from a user's finger can be used to interact with the application) or a pen-enabled interface that receives inputs from a pen or stylus. It can also use an on-screen virtual keyboard. Of course, it might also be attached to a keyboard or other user input device through a suitable attachment mechanism, such as a wireless link or USB port, for instance. Computer 600 can also illustratively receive voice inputs as well.

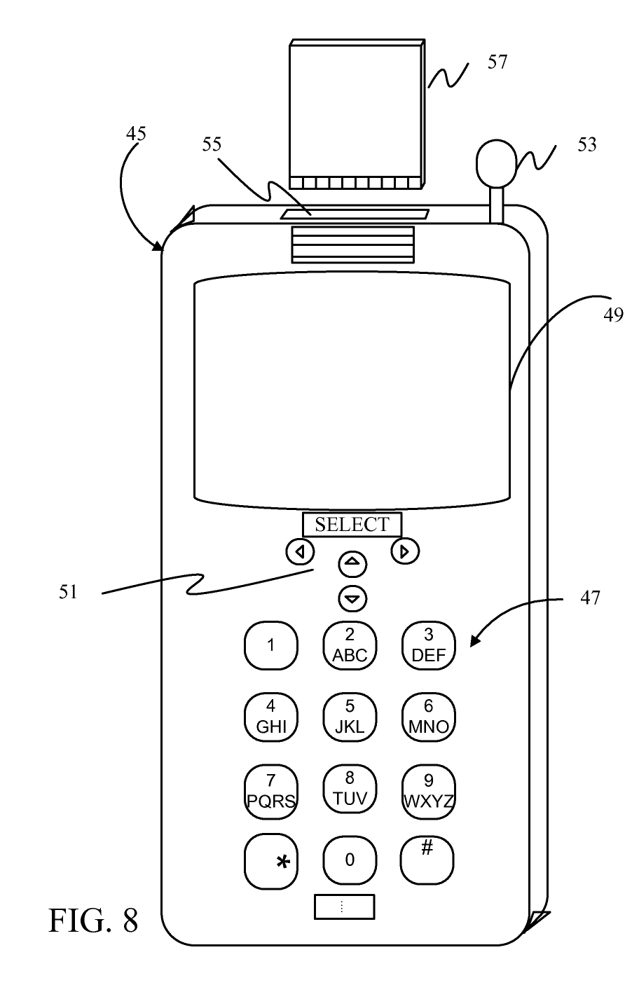

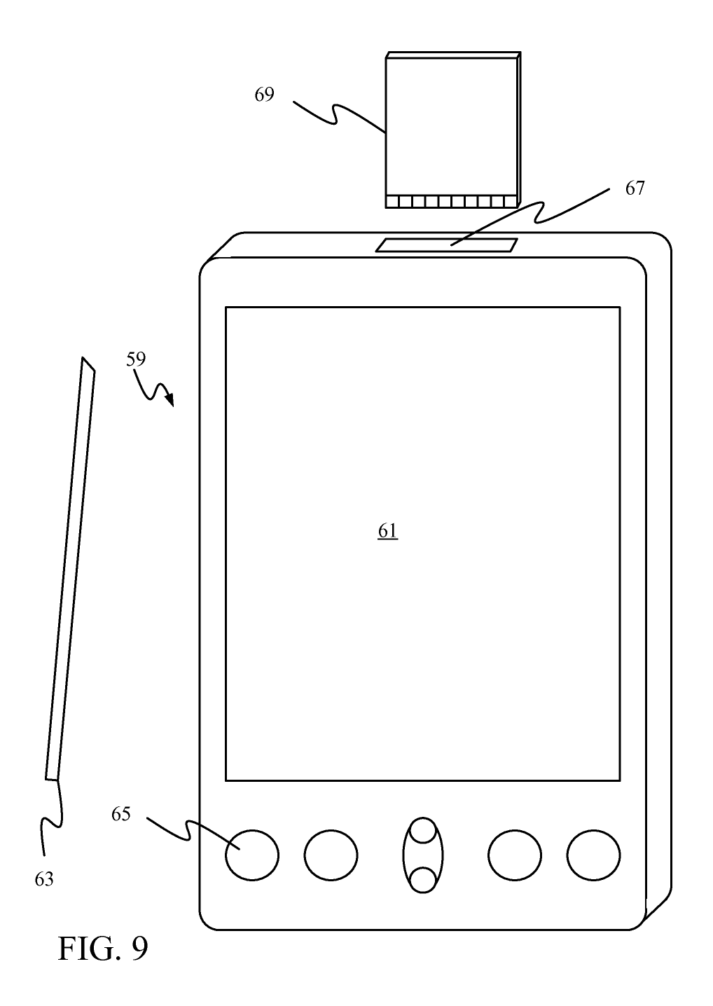

FIGS. 8 and 9 provide additional examples of devices 16 that can be used, although others can be used as well. In FIG. 8, a smart phone or mobile phone 45 is provided as the device 16. Phone 45 includes a set of keypads 47 for dialing phone numbers, a display 49 capable of displaying images including application images, icons, web pages, photographs, and video, and control buttons 51 for selecting items shown on the display. The phone includes an antenna 53 for receiving cellular phone signals such as General Packet Radio Service (GPRS) and 1×rtt, and Short Message Service (SMS) signals. In some embodiments, phone 45 also includes a Secure Digital (SD) card slot 55 that accepts a SD card 57.

The mobile device of FIG. 9 is a personal digital assistant (PDA) 59 or a multimedia player or a tablet computing device, etc. (hereinafter referred to as PDA 59). PDA 59 includes an inductive screen 61 that senses the position of a stylus 63 (or other pointers, such as a user's finger) when the stylus is positioned over the screen. This allows the user to select, highlight, and move items on the screen as well as draw and write. PDA 59 also includes a number of user input keys or buttons (such as button 65) which allow the user to scroll through menu options or other display options which are displayed on display 61, and allow the user to change applications or select user input functions, without contacting display 61. Although not shown, PDA 59 can include an internal antenna and an infrared transmitter/receiver that allow for wireless communication with other computers as well as connection ports that allow for hardware connections to other computing devices. Such hardware connections are typically made through a cradle that connects to the other computer through a serial or USB port. As such, these connections are non-network connections. In one embodiment, mobile device 59 also includes a SD card slot 67 that accepts a SD card 69.

Note that other forms of the devices 16 are possible.

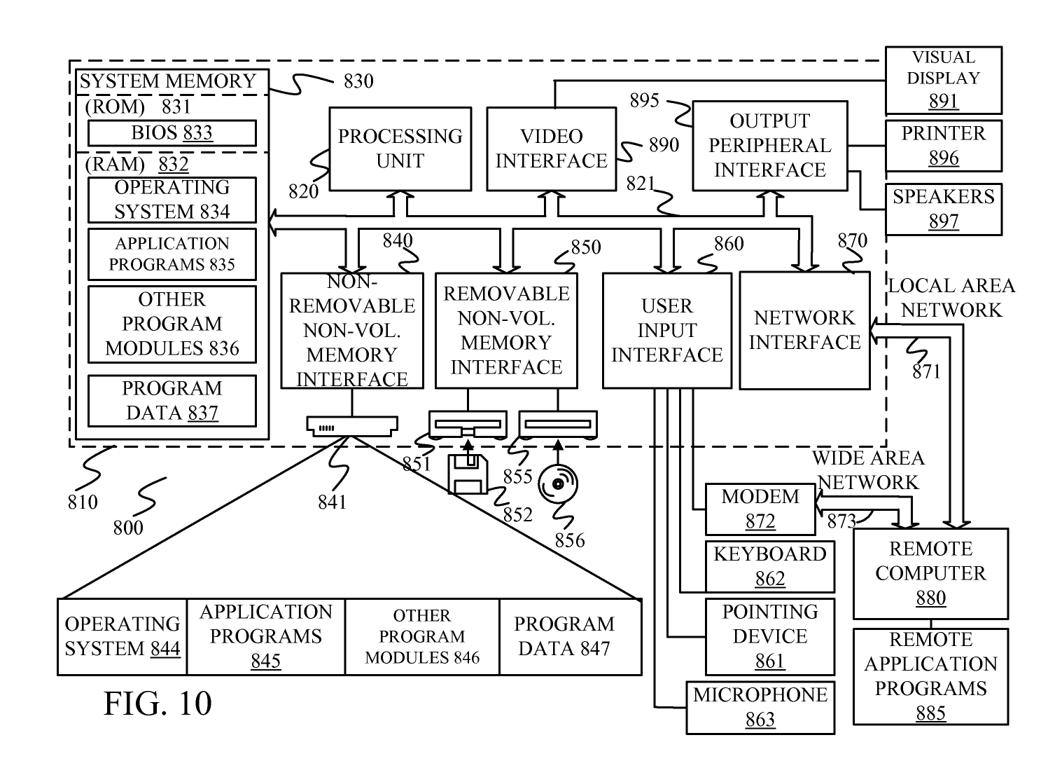

FIG. 10 is one embodiment of a computing environment in which system 100 (for example) can be deployed. With reference to FIG. 10, an exemplary system for implementing some embodiments includes a general-purpose computing device in the form of a computer 810. Components of computer 810 may include, but are not limited to, a processing unit 820 (which can comprise processor 102), a system memory 830, and a system bus 821 that couples various system components including the system memory to the processing unit 820. The system bus 821 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus. Memory and programs described with respect to FIG. 1 can be deployed in corresponding portions of FIG. 10.

Computer 810 typically includes a variety of computer readable media. Computer readable media can be any available media that can be accessed by computer 810 and includes both volatile and nonvolatile media, removable and non-removable media. By way of example, and not limitation, computer readable media may comprise computer storage media and communication media. Computer storage media is different from, and does not include, a modulated data signal or carrier wave. It includes hardware storage media including both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 810. Communication media typically embodies computer readable instructions, data structures, program modules or other data in a transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 830 includes computer storage media in the form of volatile and/or nonvolatile memory such as read only memory (ROM) 831 and random access memory (RAM) 832. A basic input/output system 833 (BIOS), containing the basic routines that help to transfer information between elements within computer 810, such as during start-up, is typically stored in ROM 831. RAM 832 typically contains data and/or program modules that are immediately accessible to and/or presently being operated on by processing unit 820. By way of example, and not limitation, FIG. 10 illustrates operating system 834, application programs 835, other program modules 836, and program data 837.

The computer 810 may also include other removable/non-removable volatile/nonvolatile computer storage media. By way of example only, FIG. 10 illustrates a hard disk drive 841 that reads from or writes to non-removable, nonvolatile magnetic media, a magnetic disk drive 851 that reads from or writes to a removable, nonvolatile magnetic disk 852, and an optical disk drive 855 that reads from or writes to a removable, nonvolatile optical disk 856 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 841 is typically connected to the system bus 821 through a non-removable memory interface such as interface 840, and magnetic disk drive 851 and optical disk drive 855 are typically connected to the system bus 821 by a removable memory interface, such as interface 850.

The drives and their associated computer storage media discussed above and illustrated in FIG. 10, provide storage of computer readable instructions, data structures, program modules and other data for the computer 810. In FIG. 10, for example, hard disk drive 841 is illustrated as storing operating system 844, application programs 845, other program modules 846, and program data 847. Note that these components can either be the same as or different from operating system 834, application programs 835, other program modules 836, and program data 837. Operating system 844, application programs 845, other program modules 846, and program data 847 are given different numbers here to illustrate that, at a minimum, they are different copies.

A user may enter commands and information into the computer 810 through input devices such as a keyboard 862, a microphone 863, and a pointing device 861, such as a mouse, trackball or touch pad. Other input devices (not shown) may include a joystick, game pad, satellite dish, scanner, or the like. These and other input devices are often connected to the processing unit 820 through a user input interface 860 that is coupled to the system bus, but may be connected by other interface and bus structures, such as a parallel port, game port or a universal serial bus (USB). A visual display 891 or other type of display device is also connected to the system bus 821 via an interface, such as a video interface 890. In addition to the monitor, computers may also include other peripheral output devices such as speakers 897 and printer 896, which may be connected through an output peripheral interface 895.

The computer 810 is operated in a networked environment using logical connections to one or more remote computers, such as a remote computer 880. The remote computer 880 may be a personal computer, a hand-held device, a server, a router, a network PC, a peer device or other common network node, and typically includes many or all of the elements described above relative to the computer 810. The logical connections depicted in FIG. 10 include a local area network (LAN) 871 and a wide area network (WAN) 873, but may also include other networks. Such networking environments are commonplace in offices, enterprise-wide computer networks, intranets and the Internet.

When used in a LAN networking environment, the computer 810 is connected to the LAN 871 through a network interface or adapter 870. When used in a WAN networking environment, the computer 810 typically includes a modem 872 or other means for establishing communications over the WAN 873, such as the Internet. The modem 872, which may be internal or external, may be connected to the system bus 821 via the user input interface 860, or other appropriate mechanism. In a networked environment, program modules depicted relative to the computer 810, or portions thereof, may be stored in the remote memory storage device. By way of example, and not limitation, FIG. 10 illustrates remote application programs 885 as residing on remote computer 880. It will be appreciated that the network connections shown are exemplary and other means of establishing a communications link between the computers may be used.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

What is claimed is:

1. A computer-implemented method of manipulating content, comprising:
displaying a user interface display including a table;
displaying a table manipulation element, on the user interface display, that is a separate display element from the table;
receiving a user touch gesture manipulating the table manipulation element on the user interface display; and
visually manipulating the table on the user interface display based on the user touch gesture.

2. The computer-implemented method of claim 1 wherein displaying the table manipulation element is performed when the user interface display including the table is displayed.

3. The computer-implemented method of claim 1 wherein displaying the table manipulation element, comprises:
receiving a user touch input placing a cursor element in the table, and displaying the table manipulation element in response to the user touch input placing the cursor element in the table.

4. The computer-implemented method of claim 1 wherein displaying a table manipulation element comprises:
displaying a table content selection element, wherein the user touch gesture manipulates the table content selection element and wherein visually manipulating the table comprises visually displaying selected table content based on user manipulation of the table selection element.

5. The computer-implemented method of claim 4 wherein the table includes a plurality of cells and wherein displaying a table content selection element comprises:
displaying a gripper element within the table and corresponding to, but offset from, a first position in a first cell.

6. The computer-implemented method of claim 5 wherein receiving a user touch gesture comprises:
receiving a user text selection input comprising movement of the gripper element so the gripper element corresponds to, but is offset from, a second position, the second position being within the first cell; and
in response to the user text selection input, selecting text within the first cell that is bounded by the first and second positions.

7. The computer-implemented method of claim 5 wherein receiving a user touch gesture comprises:
receiving a user cell selection input comprising movement of the gripper element so the gripper element corresponds to, but is offset from, a second position, the second position being outside the first cell; and
in response to the user cell selection input, selecting multiple cells based on the first and second positions.

8. The computer-implemented method of claim 4 wherein the table comprises a row and a column, and wherein displaying the table content selection element comprises:
displaying a row selection element proximate the row; and
displaying a column selection element proximate the column

9. The computer-implemented method of claim 8 wherein receiving a user touch gesture comprises:
receiving a user touch input touching either the row selection element or the column selection element; and
in response to the user touch input, selecting either the row or the column, respectively.

10. The computer-implemented method of claim 1 wherein displaying a table manipulation element comprises:
displaying a table modification element wherein the user touch gesture manipulates the table modification element and wherein visually manipulating the table comprises visually modifying layout of the table based on user manipulation of the table modification element.

11. The computer-implemented method of claim 10 wherein the table includes a row and a column and wherein displaying the table modification element comprises:
displaying a column re-size element proximate a column boundary, wherein receiving the user touch gesture comprises receiving the user touch gesture sliding the column re-size element in a given direction, and wherein visually manipulating the table comprises resizing the column by moving the column boundary in the given direction.

12. The computer-implemented method of claim 10 wherein the table includes a row and a column and wherein displaying the table modification element comprises:
displaying a row re-size element proximate a row boundary, wherein receiving the user touch gesture comprises receiving the user touch gesture sliding the row re-size element in a given direction, and wherein visually manipulating the table comprises resizing the row by moving the row boundary in the given direction.

13. The computer-implemented method of claim 10 wherein the table includes a row and a column and wherein displaying the table modification element comprises:
displaying a row addition element proximate a last row in the table, wherein receiving the user touch gesture comprises receiving the user touch gesture touching the row addition element, and wherein visually manipulating the table comprises adding a new row after the last row in the table.

14. The computer-implemented method of claim 13 wherein displaying the row addition element comprises:
displaying a phantom row, visually distinguished from the last row, in the table.

15. The computer-implemented method of claim 10 wherein the table includes a row and a column and wherein displaying the table modification element comprises:
displaying a column addition element proximate a last column in the table, wherein receiving the user touch gesture comprises receiving the user touch gesture touching the column addition element, and wherein visually manipulating the table comprises adding a new column after the last column in the table.

16. The computer-implemented method of claim 15 wherein displaying the column addition element comprises:
displaying a phantom column, visually distinguished from the last column, in the table.

17. The computer-implemented method of claim 10 wherein the table includes a plurality of rows and a plurality of columns and wherein displaying the table modification element comprises:
displaying a row or column insertion element proximate a boundary between two of the rows or columns, respectively, in the table, wherein receiving the user touch gesture comprises receiving the user touch gesture touching the row or column insertion element, and wherein visually manipulating the table comprises inserting a new row or column, respectively between the two rows or columns in the table.

18. The computer-implemented method of claim 17 wherein when the table modification element is a column insertion element, the user touch gesture moves the column insertion element in a vertical direction on the table and, where the table modification element is a row insertion element, the user touch gesture moves the row insertion element in a horizontal direction on the table, wherein visually manipulating the table comprises visually unzipping the table as the column or row insertion element is moved to insert the new column or row.

19. The computer-implemented method of claim 1 and further comprising:
performing an operation on the manipulated table.

20. A table processing system, comprising:
a touch-sensitive user interface display screen;
a table-authoring application that receives user inputs to author a table and displays a user interface display including a table, on the touch sensitive display screen;
a table manipulation component that displays a table manipulation element, on the user interface display, that is a separate display element from the table and that receives a user touch gesture manipulating the table manipulation element on the user interface display, the table manipulation component visually manipulating the table on the user interface display based on the user touch gesture; and
a computer processor being a functional part of the system and activated by the application and the table manipulation component to facilitate displaying the table manipulation element and displaying and manipulating the table.
